(19) United States
(12) Patent Application Publication
(10) Pub. No.: US 2014/0217750 A1
(43) Pub. Date: Aug. 7, 2014

(54) LATCH COMBINATION FOR DOOR OR WINDOW

(71) Applicant: THASE ENTERPRISE CO., LTD., Taipei (TW)

(72) Inventor: Ching Tien LIN, Taipei (TW)

(73) Assignee: Thase Enterprise Co., Ltd., Taipei (TW)

(21) Appl. No.: 13/761,410

(22) Filed: Feb. 7, 2013

(51) Int. Cl. E05C 7/04

(52) U.S. Cl. CPC E05C 7/045
USPC 292/156

(57) ABSTRACT

A latch combination includes an automatic latch device having a latch bolt engaged in a housing and having a free end extendible out of a door panel, an actuating member pivotally engaged with the housing and engaged with the latch bolt, a deadbolt engaged in a casing and engaged with the actuating member and having a tongue extendible out of the casing, and a spring biasing member biasing the free end of the latch bolt into the door panel and pivoting the actuating member to move the tongue of the deadbolt out of the housing, a manual latch device includes a spring biasing member biasing the free end of the latch bolt out of the door panel to normally latch the door panel to a door frame.

### BACKGROUND OF THE INVENTION

1. Field of the Invention

The present invention relates to a latch assembly or combination, and more particularly to a latch assembly or combination for a fire or emergency escape door or the like and including a simplified and adjustable structure or configuration arranged for allowing either or both of the door panels to be easily and adjustably latched or opened or actuated or operated or controlled by the users.

2. Description of the Prior Art

Various kinds of typical latch devices for fire or emergency escape doors or the like have been developed and provided for easily and quickly opening the door panels when in a fire or emergency situation or the like, and comprise one or more latch bolts for latching or locking the door panels, and a press bar mechanism provided for actuating or operating the latch bolts to selectively open and release the door panels.

For example, U.S. Pat. No. 6,883,837 to Lin, U.S. Pat. No. 6,945,571 to Lin, U.S. Pat. No. 7,287,784 to Lin, U.S. Pat. No. 7,641,244 to Lin, U.S. Pat. No. 7,918,487 to Lin, and U.S. Pat. No. 8,191,937 to Lin disclose several of the typical latch devices for fire or emergency escape doors or the like and each also comprising one or more latch bolts for latching or locking the door panels, and an actuating handle or press bar mechanism provided for actuating or operating the latch bolts to selectively open and release the door panels, and the pair of door panels or the two door panels of the fire or emergency escape doors will be simultaneously opened and released once the actuating handle or press bar mechanism is depressed or actuated or operated by the users.

However, the latch bolts are normally connected or coupled together with a complicated coupling mechanism including at least linking rods and other connecting members, such that the manufacturing processes or procedures will be complicated and the manufacturing cost will be greatly increased. Furthermore, in some cases or situations, only one of the door panels is required to be opened and the other is not, but both of the door panels will be simultaneously opened and released once the actuating handle or press bar mechanism is depressed or actuated or operated by the users.

The present invention has arisen to mitigate and/or obviate the afore-described disadvantages of the conventional latch devices for fire escape doors.

### SUMMARY OF THE INVENTION

The primary objective of the present invention is to provide a latch assembly or combination including a simplified and adjustable structure or configuration arranged for allowing either or both of the door panels to be easily and adjustably latched or opened or actuated or operated or controlled by the users.

In accordance with one aspect of the invention, there is provided a latch combination for locking a door panel to a door frame, comprising a latch device engaged into the door panel, and including a housing and a casing engaged into the door panel, and perpendicular to each other, a first latch bolt slidably engaged in the housing and including a free end extendible into and out of the door panel for locking the door panel to the door frame, an actuating member including a pivot shaft pivotally engaged with the housing, and including a first leg engaged with the first latch bolt for moving the free end of the first latch bolt into and out of the housing by pivoting the actuating member relative to the housing, the actuating member including a second leg extended outwardly therefrom, a first deadbolt slidably engaged in the casing and including a tongue extendible into and out of the casing, the second leg of the actuating member being engaged with the first deadbolt for moving the tongue of the first deadbolt into and out of the housing by pivoting the actuating member relative to the housing, and a spring biasing member engaged with the first latch bolt for moving the free end of the first latch bolt into the door panel, and for pivoting the actuating member to move the tongue of the first deadbolt out of the housing, and the actuating member being pivoted relative to the housing by the first deadbolt when the tongue of the first deadbolt is depressed into the housing, in order to move the free end of the first latch bolt into the door panel, and for allowing the free end of the first latch bolt to be biased moved into the door panel by the spring biasing member when the first deadbolt is released.

The casing includes a stop engaged into the casing for selectively engaging with the first deadbolt and for anchoring and limiting the first deadbolt to slide relative to the casing and the door panel.

The housing includes a plate attached to a first end portion of the housing for mounting the housing to the door panel, the plate includes an opening formed therein for slidably receiving and engaging with the free end of the first latch bolt.

The housing includes at least one channel formed therein, and the first latch bolt includes at least one key extended outwardly therefrom for slidably engaging with the at least one channel of the housing and for guiding the first latch bolt to move relative to the housing.

The first latch bolt includes an extension having a groove formed in the extension, and the actuating member includes an actuating pin provided in the first leg for slidably engaging with the groove of the extension of the first latch bolt and for allowing the free end of the first latch bolt to be selectively moved into and out of the housing by pivoting the actuating member relative to the housing.

The housing includes two orifices formed therein, and the actuating member includes a pivot shaft rotatably engaged with the orifices of the housing.

The casing includes a board attached to a free end portion of the casing for mounting the casing to the door panel, and the board includes a slit formed therein for slidably receiving and engaging with the tongue of the first deadbolt and for allowing the tongue of the first deadbolt to be selectively extended out of the door panel.

The latch device further includes a second deadbolt slidably received and engaged in the housing for replacing the first deadbolt, the second deadbolt includes a tongue flush with the casing and the door panel and extendible into the casing, the second leg of the actuating member is engaged with the second deadbolt for selectively moving the tongue of the second deadbolt into and out of the housing by pivoting the actuating member relative to the housing.

The latch device further includes a second latch bolt slidably received and engaged in the housing for replacing the first latch bolt, the second latch bolt includes a free end extendible into and out of the door panel for selectively latching and locking the door panel to the door frame, and the spring biasing member is engaged with the second latch bolt for biasing and forcing and moving the free end of the second latch bolt out of the door panel.

The second latch bolt includes an inclined surface formed in the free end of the second latch bolt. The housing includes a partition engaged with the spring biasing member which is engaged with the second latch bolt for biasing and forcing and moving the free end of the second latch bolt out of the door panel.

The tongue of the second deadbolt includes a cylindrical shape. The casing includes a board attached to a free end portion of the casing for mounting the casing to the door panel, and the board includes a circular opening formed therein for slidably receiving and engaging with the tongue of the second deadbolt.

The housing includes two apertures formed therein, and the actuating member includes a pivot shaft rotatably engaged with the apertures of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view illustrating an application of a latch assembly or assembly or combination in accordance with the present invention to a door facility;

FIG. 2 is a perspective view illustrating one of the latch devices of the latch assembly or combination;

FIG. 3 is an exploded view illustrating one of the latch devices of the latch assembly or combination;

FIG. 4 is a partial plan schematic view of the latch device of the latch assembly or combination;

FIG. 5 is another partial plan schematic view similar to FIG. 4, illustrating the operation of the latch device of the latch assembly or combination;

FIG. 6 is another partial perspective view similar to FIG. 5, illustrating the other arrangement or application of the latch assembly or combination;

FIG. 7 is a perspective view illustrating the other latch device of the latch assembly or combination;

FIG. 8 is an exploded view of the other latch device of the latch assembly or combination as shown in FIGS. 6 and 7;

FIG. 9 is a partial plan schematic view of the other latch device of the latch assembly or combination as shown in FIGS. 6-8; and

FIG. 10 is another partial plan schematic view similar to FIG. 9, illustrating the operation of the other latch device of the latch assembly or combination as shown in FIGS. 6-9.

### DETAILED DESCRIPTION OF THE PREFERRED EMBODIMENT

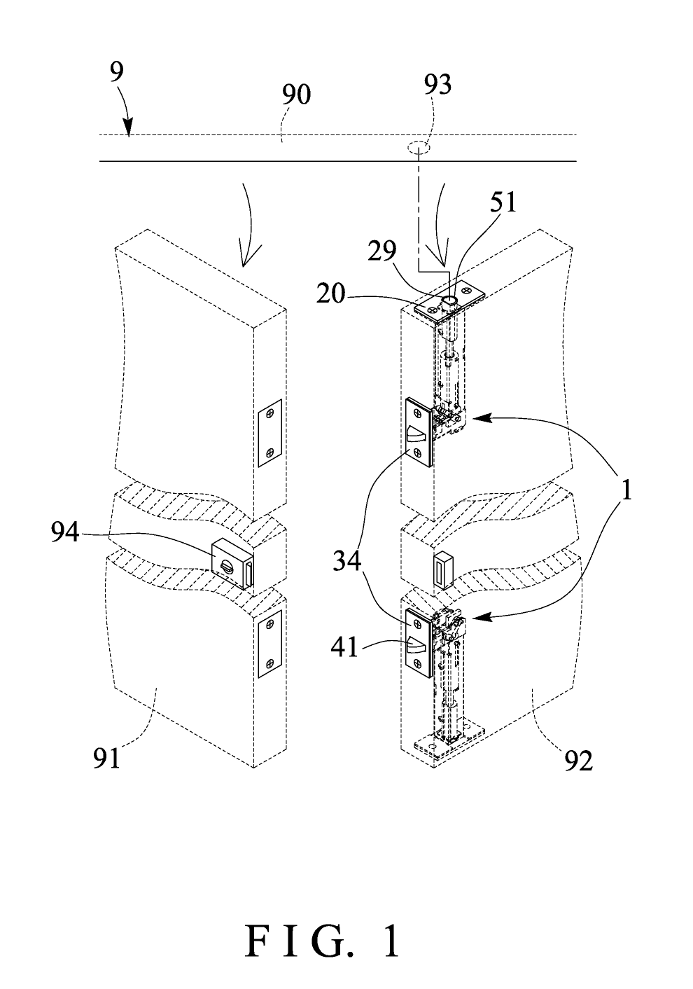

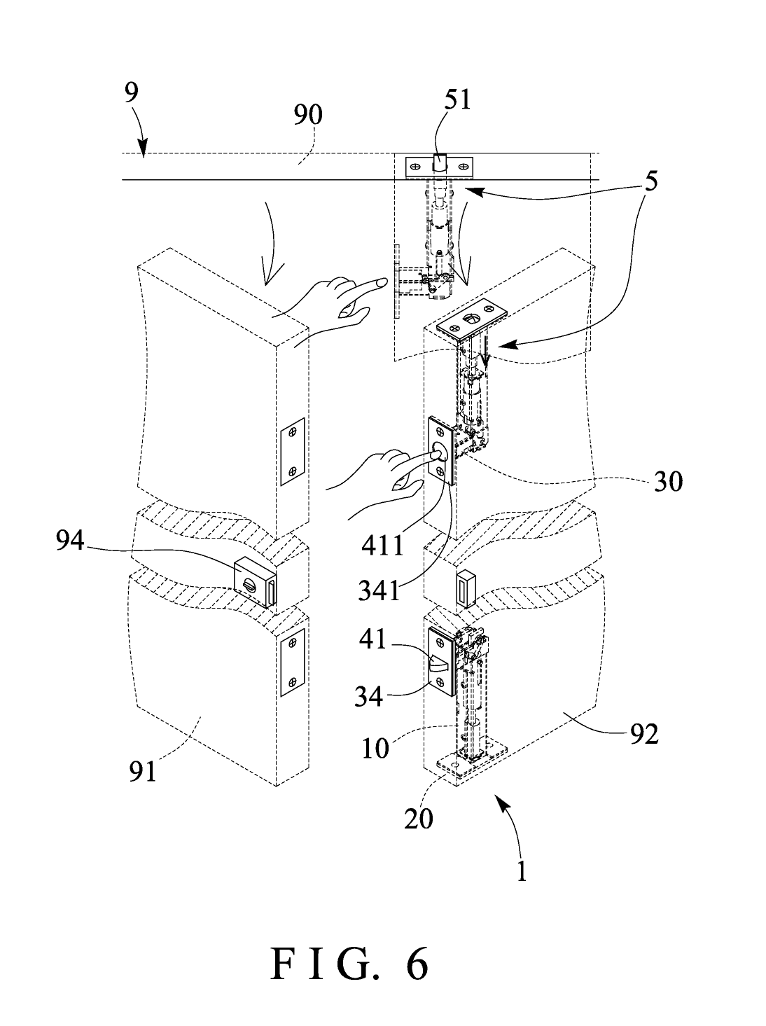

Referring to the drawings, and initially to FIGS. 1 and 6, a latch assembly or combination in accordance with the present invention is provided for attaching or mounting or securing or engaging with a fire or emergency escape door assembly or facility 9 or the like which includes a door frame 90, and two door panels 91, 92 pivotally or rotatably hinged or attached or mounted or secured or coupled to the door frame 90, and the latch combination comprises one or more (such as two) latch units or latch devices 1 (FIG. 1); or 1 and 5 (FIG. 6) disposed or attached or mounted or secured or engaged with one of the door panels or the second door panel 92, in which the door frame 90 includes one or more (such as two) holes or orifices 93 formed therein for selectively receiving or engaging with the latch devices 1 (FIG. 1); or 1 and 5 (FIG. 6) and for selectively latching or locking the door panel 92 to the door frame 90.

The other door panel 91 may further include a door lock device 94 disposed or attached or mounted or secured or engaged therein for selectively releasing or opening or latching or locking the other or the first door panel 91 to the second door panel 92 and/or to the door frame 90. The above-described structure or configuration for the door panels 91, 92 and the door frame 90 and the door lock device 94 of the fire or emergency escape door assembly or facility 9 is typical and is not related to the present invention and will not be described in further details. The latch assembly or combination in accordance with the present invention is provided and arranged for allowing the second door panel 92 to be selectively latched or locked to the door frame 90 when the first door panel 91 is latched or locked to the door frame 90 and/or to the second door panel 92 (FIG. 1); or when the first door panel 91 is not latched or locked to the door frame 90 (FIG. 6).

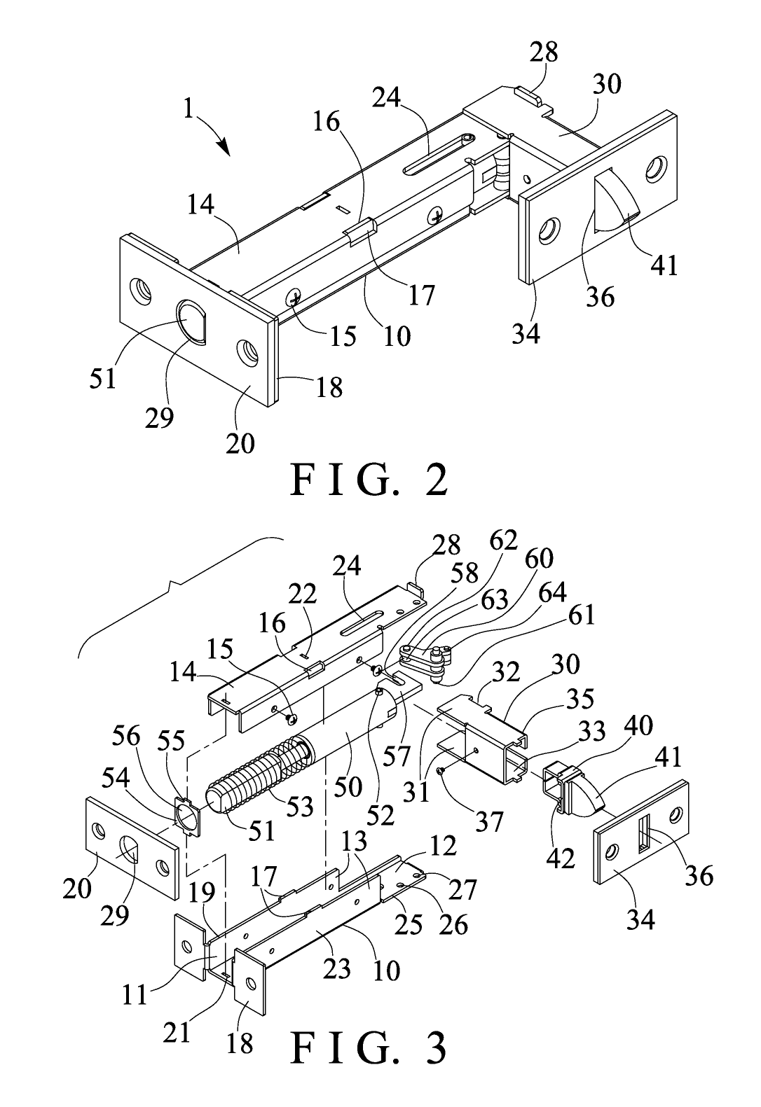

For example, as shown in FIG. 1, the second door panel 92 may be selectively latched or locked to the door frame 90 with the two identical latch devices 1, such as automatic latch devices 1; or as shown in FIG. 6, with a different or manual latch device 5 and/or one of the automatic latch devices 1, which will be described in further details hereinafter. Referring now to FIGS. 1-3, the automatic latch device 1 includes a container or receptacle or housing 10 disposed or engaged into the second door panel 92 and having a chamber 11 formed therein and formed or defined by a bottom wall or panel 12 and two side walls or panels 13, and an upper wall or panel or cover 14 attached or mounted or secured on top of the side panels 13 and/or the housing 10 with latches or fasteners 15 or the like, the housing 10 or the cover 14 may further include one or more juts or projections or notches 16 formed in the cover 14, and one or more notches or juts or projections 17 extended or formed in the housing 10 for engaging with the notches 16 of the cover 14 and for further anchoring or retaining or securing or positioning the cover 14 to the housing 10.

The housing 10 further includes one or more (such as two) ears or flaps 18 extended laterally and outwardly therefrom, such as extended outwardly from the one end or first end portion 19 of the housing 10 for engaging with a plate 20 and for attaching or mounting or securing or coupling to the second door panel 92 (FIGS. 1, 4-6, 9-10), one or more (such as two) apertures or orifices or holes or cavities 21 oppositely formed in the cover 14 and the bottom panel 12 at the first end portion 19 of the housing 10, one or more (such as two) orifices or apertures or holes 22 also oppositely formed in the cover 14 and the bottom panel 12, but at the middle or intermediate portion 23 of the housing 10, one or more (such as two) slots or grooves or channels 24 also oppositely formed in the cover 14 and the bottom panel 12, but at the other end or second end portion 25 of the housing 10, two orifices 26 and two apertures 27 also oppositely formed in the cover 14 and the bottom panel 12, but at the second end portion 25 of the housing 10, and two juts or projections or flaps or ears 28 oppositely extended outwardly from the second end portion 25 of the housing 10.

A casing 30 is also disposed or engaged into the second door panel 92 and includes one or more (such as two) ears or flaps or juts or projections or extensions 31 attached or mounted or secured to the second end portion 25 of the housing 10 with latches or fasteners or adhesive materials or by welders, and includes one or more recesses 32 formed in the extensions 31 for receiving or engaging with the ears 28 of the housing 10 and for further anchoring or retaining or securing or positioning the casing 30 to the housing 10, in which the casing 30 is arranged perpendicular to the housing 10 or laterally extended outwardly from the housing 10, and the casing 30 includes a compartment 33 formed therein and communicating with the chamber 11 of the housing 10 for slidably receiving or engaging with a deadbolt 40 which includes a tongue 41 extendible out of the casing 30.

A plate or board 34 is attached or mounted or secured to an outer or free end portion 35 of the casing 30 for attaching or mounting or coupling or retaining or positioning or securing the casing 30 to the second door panel 92 (FIGS. 1, 4-6, 9-10), and includes a slit 36 formed therein (FIG. 3) for slidably receiving or engaging with the tongue 41 of the deadbolt 40 and arranged for allowing the tongue 41 of the deadbolt 40 to be selectively extended out of the second door panel 92 (FIGS. 1-2, 4, and 6), and to be selectively depressed or forced into the second door panel 92 (FIG. 5) with the first door panel 91, for example. A latch or fastener or stop 37 (FIG. 3) is attached or mounted or secured to the casing 30 and extended or engaged into the compartment 33 of the casing 30 for selectively engaging with a stop or anchoring member or protrusion 42 of the deadbolt 40 and for anchoring or limiting the deadbolt 40 to slide or move relative to the casing 30 and the second door panel 92.

A latch bolt 50 is slidably received or engaged in the chamber 11 of the housing 10 and includes a tongue or free end 51 slidably received or engaged through an opening 29 of the plate 20 (FIGS. 1-2, 5) for selectively engaging or extending out of the second door panel 92 (FIG. 5) and for selectively engaging with the orifices 93 of the door frame 90 (FIG. 1) and for selectively extending out of the second door panel 92 (FIG. 5) and for selectively latching or locking the door panel 92 to the door frame 90. The latch bolt 50 includes one or more (such as two) juts or projections or extensions or guiding members or pegs or keys 52 extended outwardly therefrom for slidably engaging with the channels 24 of the housing 10 and for guiding the latch bolt 50 to move or slide relative to the housing 10 and for preventing the latch bolt 50 from being pivoted or rotated relative to the housing 10.

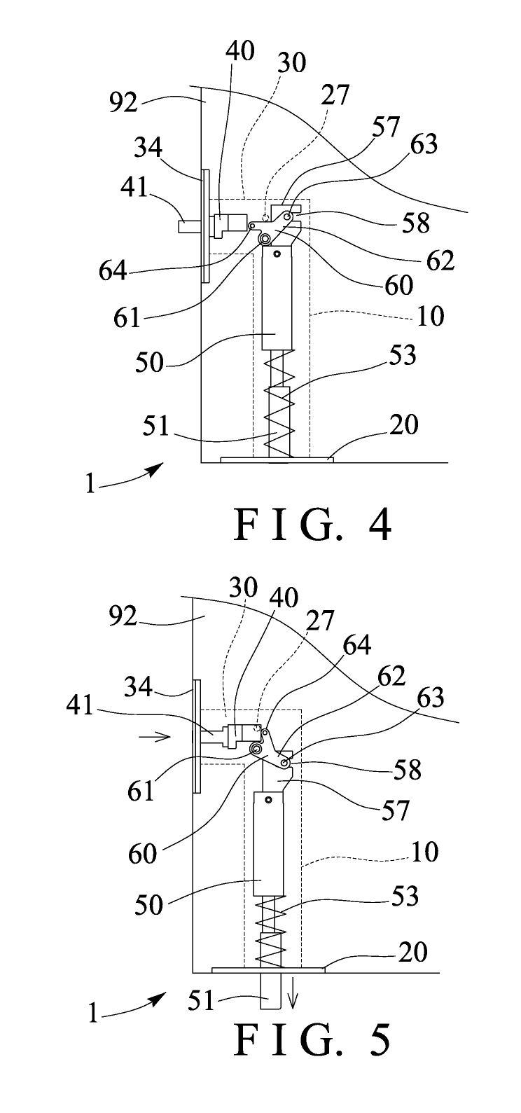

A spring biasing member 53 is attached or mounted or engaged onto the latch bolt 50 and disposed or contacted or engaged between the latch bolt 50 and the plate 20 and/or the second door panel 92 (FIGS. 4, 5) for biasing and forcing or moving the tongue or free end 51 of the latch bolt 50 into the second door panel 92 (FIG. 4). The housing 10 may further include a plate or board or stop or partition 54 having one or more (such as two) juts or projections or keys or pegs 55 extended outwardly therefrom for selectively engaging with the cavities 21 of the housing 10 and for selectively attaching or mounting or securing the partition 54 to the one end or first end portion 19 of the housing 10, and the partition 54 includes a hole 56 formed therein for slidably receiving or engaging with the tongue or free end 51 of the latch bolt 50 and for optionally contacting or engaging the spring biasing member 53. However, without the partition 54, the spring biasing member 53 may be directly contacted or engaged with the plate 20 and/or the second door panel 92.

The latch bolt 50 further includes a flap or ear or projection or extension 57 extended outwardly therefrom, such as extended opposite to or away from the free end 51 of the latch bolt 50 and includes a slit or slot or guide channel or groove 58 formed therein. A cam or operating or controlling or actuating member 60 is pivotally or rotatably hinged or attached or mounted or secured or coupled to the housing 10, at the second end portion 25 of the housing 10, for example, the actuating member 60 includes a pivot pin or axle or shaft 61 pivotally or rotatably engaged with the orifices 26 of the housing 10, and includes a first end or first leg 62 having an actuating pin 63 disposed or provided thereon for slidably engaging with the groove 58 of the extension 57 of the latch bolt 50 and arranged for allowing the free end 51 of the latch bolt 50 to be selectively moved into and out of the housing 10 by pivoting or rotating the actuating member 60 relative to the housing 10.

The actuating member 60 further includes another or second end or second leg 64 extended outwardly therefrom for forming or defining an r or y-shaped structure or configuration together with the first end or first leg 62 of the actuating member 60, best shown in FIGS. 4-5 and 9-10, and the second end or second leg 64 of the actuating member 60 is provided for selectively contacting or engaging the deadbolt 40 and arranged for allowing the actuating member 60 to be pivoted or rotated relative to the housing 10 by or with the deadbolt 40 in order to selectively actuate or operate or move the free end 51 of the latch bolt 50 into and out of the housing 10. For example, as shown in FIG. 5, when the deadbolt 40 is actuated or operated or depressed into the housing 10, the actuating member 60 may be pivoted or rotated relative to the housing 10 by the deadbolt 40 in order to move the latch bolt 50 onto and against the spring biasing member 53 so as to move the free end 51 of the latch bolt 50 out of the housing 10.

In operation, as shown in FIGS. 1-2 and 4, when the deadbolts 40 are not actuated or operated or depressed into the casing 30 or the second door panel 92, or when the deadbolts 40 are released, the spring biasing member 53 may bias and force and move the free ends 51 of the latch bolts 50 into the housing 10 and the second door panel 92 and may pivot or rotate the actuating members 60 relative to the housing 10 in order to move or extend the tongues 41 of the deadbolts 40 out of the casings 30 and the second door panel 92, at this moment, the second door panel 92 is not and will not be latched or locked to the door frame 90 and may be freely pivoted or rotated relative to the door frame 90. The second door panel 92 may include one or more (such as two) automatic latch devices 1 disposed or engaged therein.

When the free ends 51 of the latch bolts 50 are aligned with the orifices 93 of the door frame 90 and when the two door panels 91, 92 are aligned with the door frame 90, the first door panel 91 may actuate or operate or move or depress the tongues 41 of the deadbolts 40 into the casings 30 or the second door panel 92 (FIG. 5) and may pivot or rotate the actuating member 60 relative to the housing 10 in order to move or extend the free ends 51 of the latch bolts 50 out of the housing 10 and the second door panel 92 and into the orifices 93 of the door frame 90 such that the second door panel 92 may be selectively latched or locked to the first door panel 91 and/or the door frame 90 with the first door panel 91, and the first door panel 91 may further be selectively latched or locked to the door frame 90 with the door lock device 94.

When the first door panel 91 is opened and released or pivoted or rotated relative to the door frame 90 and moved away from the second door panel 92, the spring biasing member 53 may bias and force and move the free end 51 of the latch bolt 50 into the housing 10 and the second door panel 92 again and may pivot or rotate the actuating member 60 relative to the housing 10 in order to move or extend the tongue 41 of the deadbolt 40 out of the casing 30 and the second door panel 92 (FIG. 4) and so as to open and release the second door panel 92, such that the two door panels 91, 92 may be easily and quickly opened and released from the door frame 90 simply by pivoting or rotating and opening and releasing the first door panel 91 from or relative to the second door panel 92.

Referring next to FIGS. 6-10, the second door panel 92 may include a different or manual latch device 5 disposed or engaged therein and having a structure or configuration similar to the automatic latch devices 1. For example, the manual latch device 5 also includes a casing 30 and a housing 10 identical to that of the automatic latch devices 1, a different or second latch bolt 501 similar to the first latch bolt 50 of the automatic latch device 1 except that the second latch bolt 501 includes a tilted or inclined surface 59 formed in the free end 51 thereof (FIG. 8), and a different or second deadbolt 401 similar to the first deadbolt 40 of the automatic latch device 1 except that the second deadbolt 401 includes a disc or cylindrical-shaped tongue 411, and the board 341 includes a circular opening 361 formed therein (FIG. 8) for slidably receiving or engaging with the disc or cylindrical-shaped tongue 411 of the second deadbolt 401 and arranged for allowing the tongue 411 of the second deadbolt 401 to be selectively extended into the circular opening 361 of the board 341.

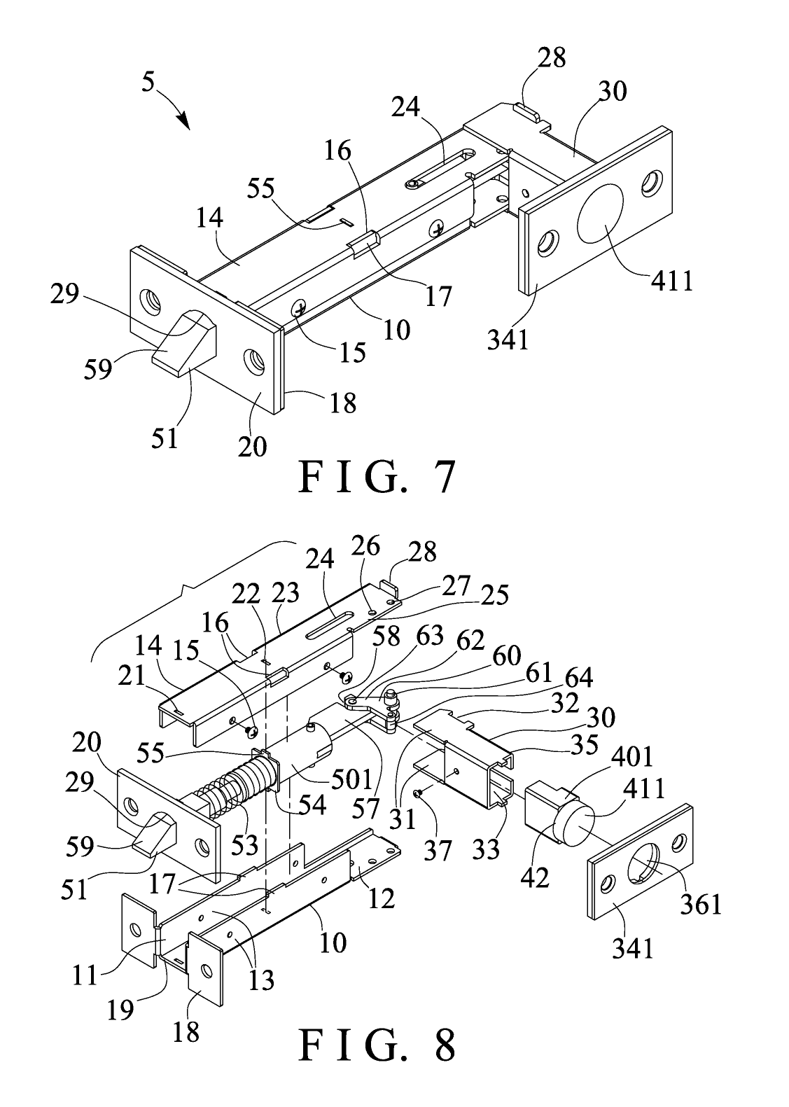

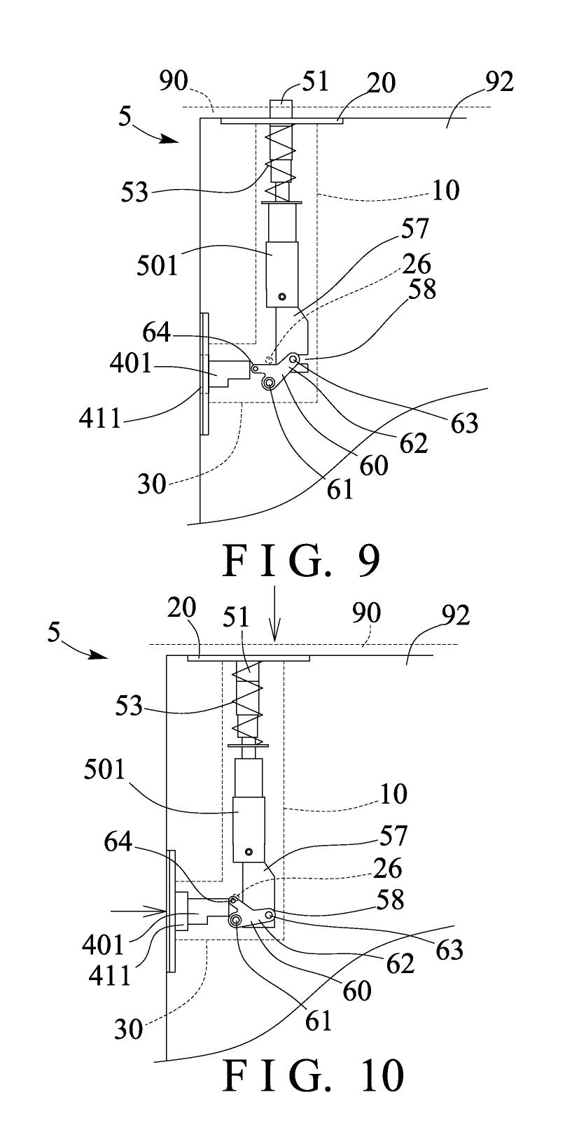

As shown in FIGS. 6 and 10, the tongue 411 of the second deadbolt 401 is depressible or pressable into the casing 30 (FIG. 10), and will be flush with the board 341 or the casing 30 or the second door panel 92 (FIGS. 7, 9) and will not be extended out of the board 341 and the second door panel 92, and thus will not be actuated or operated or depressed into the housing 10 by or with the second door panel 92. The stop or anchoring member or protrusion 42 of the second deadbolt 401 (FIG. 8) may be engaged with the casing 30 for anchoring or guiding or limiting the second deadbolt 401 to slide or move relative to the casing 30 and the second door panel 92. The actuating member 60 of the manual latch device 5 is identical to that of the automatic latch devices 1, except that the actuating member 60 of the manual latch device 5 is disposed up-side-down and except that the pivot shaft 61 of the actuating member 60 is pivotally or rotatably engaged with the apertures 27, but not the orifices 26 of the housing 10.

The actuating member 60 of the manual latch device 5 also includes a first end or first leg 62 having an actuating pin 63 disposed or provided thereon for slidably engaging with the groove 58 of the extension 57 of the second latch bolt 501 and arranged for allowing the free end 51 of the second latch bolt 501 to be selectively moved into and out of the housing 10 by pivoting or rotating the actuating member 60 relative to the housing 10. The actuating member 60 of the manual latch device 5 also includes a second end or leg 64 provided for selectively contacting or engaging the second deadbolt 401 and arranged for allowing the actuating member 60 to be pivoted or rotated relative to the housing 10 by or with the second deadbolt 401 in order to selectively actuate or operate or move the free end 51 of the second latch bolt 501 into and out of the housing 10.

The pegs 55 of the partition 54 (FIG. 8) are selectively engaged with the holes 22, but not the cavities 21 of the housing 10 and for selectively attaching or mounting or securing the partition 54 to the middle or intermediate portion 23 of the housing 10, and the partition 54 is provided and arranged for engaging with the spring biasing member 53 which is also engaged with the second latch bolt 501 for biasing and forcing or moving the tongue or free end 51 of the second latch bolt 501 out of the second door panel 92 (FIG. 9) in order to normally bias and engage the tongue or free end 51 of the second latch bolt 501 with the orifice 93 of the door frame 90 even when the first door panel 91 is opened and released or pivoted or rotated relative to the door frame 90 and moved away from the second door panel 92, such that the second door panel 92 may be normally latched or locked to the door frame 90 with the manual latch device 5.

The second door panel 92 may be selectively opened and released or pivoted or rotated relative to the door frame 90 and moved away from the door frame 90 by pressing or depressing the tongue 411 of the second deadbolt 401 into the casing 30 (FIG. 10), in order to selectively pivot or rotate the actuating members 60 relative to the housing 10 so as to force and move the tongue or free end 51 of the second latch bolt 501 into the second door panel 92 (FIG. 10). In operation, as shown in FIG. 6, the tongue 41 of the first deadbolt 40 may be extended out of the casing 30 and the second door panel 92 (FIG. 4) and the automatic latch device 1 may be released or unlocked from or relative to the door frame 90 when the first door panel 91 is moved away from the second door panel 92, and the second door panel 92 may be normally latched or locked to the door frame 90 with the manual latch device 5 (FIG. 9) unless the tongue 411 of the second deadbolt 401 is depressed or pressed into the casing 30 by the user, in order to force and move the tongue or free end 51 of the second latch bolt 501 into the second door panel 92 (FIG. 10).

It is to be noted that the casings 30 and the housings 10 and the actuating members 60 of the automatic latch devices 1 and the manual latch device 5 are identical to each other, such that the casings 30 and the housings 10 and the actuating members 60 may be replaced and used for both the automatic latch devices 1 and the manual latch device 5, and such that the manufacturing procedures for the latch assembly or combination will be greatly simplified, in addition, the deadbolts 40, 401 and the latch bolt 50, 501 of the automatic latch devices 1 and the manual latch device 5 are similar to each other and may also be easily and quickly manufactured by the workers.

Accordingly, the latch assembly or combination in accordance with the present invention includes a simplified and adjustable structure or configuration arranged for allowing either or both of the door panels to be easily and adjustably latched or opened or actuated or operated or controlled by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A latch combination for selectively latching and locking a door panel to a door frame, comprising:
a latch device engaged into said door panel, and including:
a housing and a casing engaged into said door panel, and perpendicular to each other,
a first latch bolt slidably received and engaged in said housing and including a free end extendible into and out of said door panel for selectively latching and locking said door panel to said door frame,
an actuating member including a pivot shaft pivotally engaged with said housing, and including a first leg engaged with said first latch bolt for selectively moving said free end of said first latch bolt into and out of said housing by pivoting said actuating member relative to said housing, said actuating member including a second leg extended outwardly therefrom,
a first deadbolt slidably received and engaged in said casing and including a tongue extendible into and out of said casing, said second leg of said actuating member being engaged with said first deadbolt for selectively moving said tongue of said first deadbolt into and out of said housing by pivoting said actuating member relative to said housing, and
a spring biasing member engaged with said first latch bolt for selectively biasing and forcing and moving said free end of said first latch bolt into said door panel, and for selectively pivoting said actuating member to move said tongue of said first deadbolt out of said housing, and
said actuating member being pivoted relative to said housing by said first deadbolt when said tongue of said first deadbolt is depressed into said housing, in order to move said free end of said first latch bolt into said door panel, and for allowing said free end of said first latch bolt to be biased and forced and moved into said door panel by said spring biasing member when said first deadbolt is released.

2. The latch combination as claimed in claim 1, wherein said casing includes a stop engaged into said casing for selectively engaging with said first deadbolt and for anchoring and limiting said first deadbolt to slide relative to said casing and said door panel.

3. The latch combination as claimed in claim 1, wherein said housing includes a plate attached to a first end portion of said housing for mounting said housing to said door panel, said plate includes an opening formed therein for slidably receiving and engaging with said free end of said first latch bolt.

4. The latch combination as claimed in claim 1, wherein said housing includes at least one channel formed therein, and said first latch bolt includes at least one key extended outwardly therefrom for slidably engaging with said at least one channel of said housing and for guiding said first latch bolt to move relative to said housing.

5. The latch combination as claimed in claim 1, wherein said first latch bolt includes an extension having a groove formed in said extension, and said actuating member includes an actuating pin provided in said first leg for slidably engaging with said groove of said extension of said first latch bolt and for allowing said free end of said first latch bolt to be selectively moved into and out of said housing by pivoting said actuating member relative to said housing.

6. The latch combination as claimed in claim 1, wherein said housing includes two orifices formed therein, and said actuating member includes a pivot shaft rotatably engaged with said orifices of said housing.

7. The latch combination as claimed in claim 1, wherein said casing includes a board attached to a free end portion of said casing for mounting said casing to said door panel, and said board includes a slit formed therein for slidably receiving and engaging with said tongue of said first deadbolt and for allowing said tongue of said first deadbolt to be selectively extended out of said door panel.

8. The latch combination as claimed in claim 1, wherein said latch device further includes a second deadbolt slidably received and engaged in said housing for replacing said first deadbolt, said second deadbolt includes a tongue flush with said casing and said door panel and extendible into said casing, said second leg of said actuating member is engaged with said second deadbolt for selectively moving said tongue of said second deadbolt into and out of said housing by pivoting said actuating member relative to said housing.

9. The latch combination as claimed in claim 8, wherein said latch device further includes a second latch bolt slidably received and engaged in said housing for replacing said first latch bolt, said second latch bolt includes a free end extendible into and out of said door panel for selectively latching and locking said door panel to said door frame, and said spring biasing member is engaged with said second latch bolt for biasing and forcing and moving said free end of said second latch bolt out of said door panel.

10. The latch combination as claimed in claim 9, wherein said second latch bolt includes an inclined surface formed in said free end of said second latch bolt.

11. The latch combination as claimed in claim 9, wherein said housing includes a partition engaged with the spring biasing member which is engaged with the second latch bolt for biasing and forcing and moving the free end of the second latch bolt out of the door panel.

12. The latch combination as claimed in claim 8, wherein said tongue of said second deadbolt includes a cylindrical shape.

13. The latch combination as claimed in claim 12, wherein said casing includes a board attached to a free end portion of said casing for mounting said casing to said door panel, and said board includes a circular opening formed therein for slidably receiving and engaging with said tongue of said second deadbolt.

14. The latch combination as claimed in claim 8, wherein said housing includes two apertures formed therein, and said actuating member includes a pivot shaft rotatably engaged with said apertures of said housing.

15. A latch combination for selectively latching and locking a door panel to a door frame, comprising:
an automatic latch device engaged into said door panel, and including:
a first housing and a first casing engaged into said door panel, and perpendicular to each other,
a first latch bolt slidably received and engaged in said first housing and including a free end extendible into and out of said door panel for selectively latching and locking said door panel to said door frame,
a first actuating member including a pivot shaft pivotally engaged with said first housing, and including a first leg engaged with said first latch bolt for selectively moving said free end of said first latch bolt into and out of said first housing by pivoting said actuating member relative to said first housing, said actuating member including a second leg extended outwardly therefrom,
a first deadbolt slidably received and engaged in said first casing and including a tongue extendible into and out of said first casing, said second leg of said first actuating member being engaged with said first deadbolt for selectively moving said tongue of said first deadbolt into and out of said first housing by pivoting said first actuating member relative to said first housing, and
a spring biasing member engaged with said first latch bolt for selectively biasing and forcing and moving said free end of said first latch bolt into said door panel, and for selectively pivoting said actuating member to move said tongue of said first deadbolt out of said first housing, and
said actuating member being pivoted relative to said first housing by said first deadbolt when said tongue of said first deadbolt is depressed into said first housing, in order to move said free end of said first latch bolt into said door panel, and for allowing said free end of said first latch bolt to be biased and forced and moved into said door panel by said spring biasing member when said first deadbolt is released.

16. The latch combination as claimed in claim 15, wherein said first casing includes a stop engaged into said first casing for selectively engaging with said first deadbolt and for anchoring and limiting said first deadbolt to slide relative to said first casing and said door panel.

17. The latch combination as claimed in claim 15, wherein said first housing includes at least one channel formed therein, and said first latch bolt includes at least one key extended outwardly therefrom for slidably engaging with said at least one channel of said first housing and for guiding said first latch bolt to move relative to said first housing.

18. The latch combination as claimed in claim 1, wherein said first latch bolt includes an extension having a groove formed in said extension, and said first actuating member includes an actuating pin provided in said first leg for slidably engaging with said groove of said extension of said first latch bolt and for allowing said free end of said first latch bolt to be selectively moved into and out of said first housing by pivoting said actuating member relative to said first housing.

19. The latch combination as claimed in claim 15 further comprising a manual latch device engaged into said door panel, and including a second housing and a second casing engaged into said door panel, and perpendicular to each other, a second latch bolt slidably received and engaged in said second housing and including a free end extendible into and out of said door panel for selectively latching and locking said door panel to said door frame, a second actuating member including a pivot shaft pivotally engaged with said second housing, and including a first leg engaged with said second latch bolt for selectively moving said free end of said second latch bolt into and out of said second housing by pivoting said actuating member relative to said second housing, said second actuating member including a second leg extended outwardly therefrom, a second deadbolt slidably received and engaged in said second casing and including a tongue extendible into and out of said second casing, said second leg of said second actuating member being engaged with said second deadbolt for selectively moving said tongue of said second deadbolt into and out of said second housing by pivoting said actuating member relative to said second housing, and a spring biasing member engaged with said second latch bolt for selectively biasing and forcing and moving said free end of said second latch bolt into said door panel, and for selectively pivoting said second actuating member to move said tongue of said second deadbolt out of said second housing, and said second actuating member being pivoted relative to said second housing by said second deadbolt when said tongue of said second deadbolt is depressed into said second housing, in order to move said free end of said second latch bolt into said door panel, and for allowing said free end of said second latch bolt to be biased and forced and moved into said door panel by said spring biasing member when said second deadbolt is released.
